(19) United States
(12) Patent Application Publication
(10) Pub. No.: US 2015/0331651 A1
(43) Pub. Date: Nov. 19, 2015

(54) REDUCTION OF THE DATA VOLUME OF PRINT RESOURCES

(71) Applicant: OCÉ PRINTING SYSTEMS GMBH & CO. KG, Poing (DE)

(72) Inventor: Gerhard Brandl, Munich (DE)

(73) Assignee: Oce Prubtubg Systems GmbH & Co. KG, Poing (DE)

(21) Appl. No.: 14/711,857

(22) Filed: May 14, 2015

(30) Foreign Application Priority Data
May 14, 2014 (DE) 102014106762.2

(51) Int. Cl. G06F 3/12

(52) U.S. Cl. CPC G06F 3/1296; G06F 3/122; G06F 3/1211; G06F 3/1229; G06F 3/126

(57) ABSTRACT

In a method to determine print resources for creation of a print image via a printing device, print data from which the printing device should create a print image print is determined. A first print resource is identified based on the print data, a resource file of the first print resource including usable data that enable the printing device to determine a graphical depiction of the print image, and the resource file including metadata. The first identifier of the first print resource is determined, the first identifier depending on the usable data of the first print resource, and the first identifier being independent of the metadata. Based on the first identifier, a check is made whether the first print resource is already stored in a storage unit of the printing device. The print image to be created is reduced by means of the first print resource, the first print resource not being re-transferred from the control system to the printing device if it is determined that the first print resource is already stored in the storage unit.

### BACKGROUND

The disclosure concerns printing systems. In particular, the disclosure concerns a method and a corresponding device to reduce the data volume of printing resources for printing systems.

Within the scope of a print job in a printing device, primary print data and/or print resources relating to content are typically transferred to the printing device for the creation of a print image. The print resources typically include one or more resource files. For example, a resource file includes the description of a type font, i.e. information that enables the printing device to print out specific parts of the print job with a type font described in the resource file.

Print resources that have already been used are often stored in a storage device of the printing device, possibly in order to again allow access to the stored print resources as needed. With time, the storage space available for new print resources in the storage device of the printing device may thus be consumed. New print resources may then only be transferred to the printing device and can be used by the printing device after print resources already stored on the storage device have been deleted. This process takes up computation time, which may lead to an unwanted start/stop operation or decreased printing speed of the printing device and/or to a spoilage printing.

Furthermore, the deletion of already stored print resources may lead to the situation that print resources that have already been used must be transferred to the printing device again if needed. This leads to an increased data volume in the transfer medium to the printing device.

### SUMMARY

It is an object to reduce the data volume of the print resources that must be transferred to the printing device and/or that must be stored in a storage unit of the printing device. The required bandwidth in a transfer medium to the printing device may thus be reduced. Furthermore, the probability of an unwanted start/stop operation or decreased print speed of the printing device and/or of a spoilage printing may thus be reduced.

In a method to determine print resources for creation of a print image via a printing device, print data from which the printing device should create a print image print is determined. A first print resource is identified based on the print data, a resource file of the first print resource including usable data that enable the printing device to determine a graphical depiction of the print image, and the resource file including metadata. The first identifier of the first print resource is determined, the first identifier depending on the usable data of the first print resource, and the first identifier being independent of the metadata. Based on the first identifier, a check is made whether the first print resource is already stored in a storage unit of the printing device. The print image to be created is reduced by means of the first print resource, the first print resource not being re-transferred from the control system to the printing device if it is determined that the first print resource is already stored in the storage unit.

### BRIEF DESCRIPTION OF THE DRAWINGS

FIG. 1 illustrates an example of a printing system;

FIG. 2 illustrates an example of a design of a print job and of a resource file;

FIG. 3 illustrates a workflow diagram of an example method for identification of a print resource; and

FIGS. 4a and 4b illustrate exemplary reuse of print resources in different print files.

### DESCRIPTION OF EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included herein.

It is to be noted that the methods, devices and systems described in this disclosure may be used both alone and in combination with other methods, devices and systems described in this document. Furthermore, any aspects of the method, device and system described in this disclosure may be combined with one another in numerous ways.

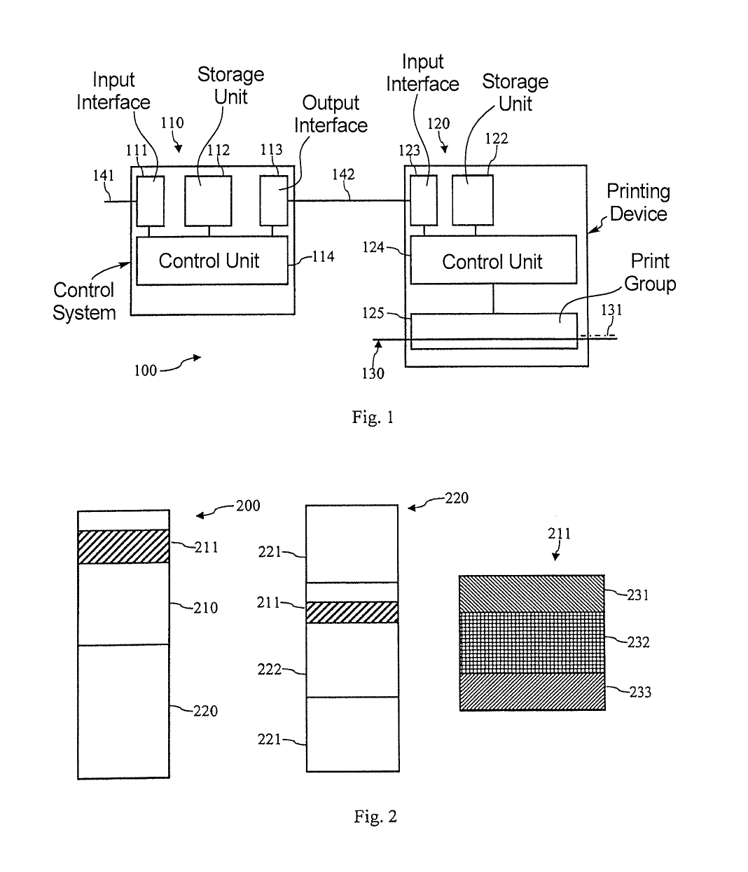

As was presented above, the present document deals with the efficient transfer and storage of print resources to or in a printing device. In this context, FIG. 1 shows a block diagram of an example printing system 100. The printing system 100 comprises a control system 110 that is set up to create a print job for a printing device 120. For example, the control system 110 may comprise a server at which a control software for the printing device 120 is executed. The control system 110 may receive print data (i.e. data to be printed) via an input interface 111 of the control system 110. Example print data are text documents (for example invoices) to be printed, for example. The print data may be transferred to the control system 110 via a first transfer medium 141 (via a first LAN connection, for example). The print data may be processed by a control unit 114 of the control system 110 (by a processor 114, for example) in order to create a print job for the printing device 120. Portions of the print data (print resources, for example) may be stored in a storage unit 112 of the control system 110.

The print job determined from the print data may be transferred via an output interface 113 of the control system 110 and via an additional transfer medium 142 (via an additional LAN connection, for example) to the printing device 120. The print job may include concrete instructions to the printing device that induce the printing device 120 to print the print data in the desired form as a print image 131 on a recording medium 130 (on paper, for example). The printing device 120 may comprise a high-capacity printer to print to web-shaped or sheet-shaped recording media 130.

Print resources may also be transferred with the print job to the printing device 120. The print resources may indicate with which graphical presentation specific elements of the print data are to be printed. For example, the print resources may include a description of the graphical appearance of a font or of a typeface with which text from the print data is to be printed. Furthermore, the print resources may include image information (for logos, for example) that enable the printing device 120 to print out images (logos, for example) included in the print data.

The print resources may include one or more resource files. For example, a resource file may describe the graphical reproduction of a specific font or of a specific typeface. The description of a font may be pixel-based or vector-based. Given a pixel-based description, the individual letters of the font are described point-by-point (i.e. pixel-by-pixel). Given a vector-based description, the individual letters of a font are described by mathematical functions (by splines, for example). Alternatively or additionally, a graphic or image (a logo, for example) may be described by a resource file.

The printing device 120 comprises an input interface 123 via which the print job may be received by the control unit 110. For example, the print job may include Intelligent Printer Data Stream (IPDS) data. Furthermore, the printing device 120 comprises a control unit 124 (for example one or more processors) in order to process the print job. In particular, the control unit 124 of the printing device 120 may be set up to evaluate graphical information included in a resource file. The resource file may thereby be rasterized. Given a resource file that describes a font, the rasterization may—for example—lead to the situation that the printing device 120 creates a corresponding virtual print image for each letter of the font, which virtual print image is applied on the recording medium 130 as needed for the respective letter. The rasterization is typically relatively computationally intensive. In order to avoid that a new rastering must take place given repeated use of the same print resource (for example given repeated use of the same font), the print resources and/or the corresponding rasterized virtual print images are stored in a storage unit 122 of the printing device 120. Given the execution of a print job, the control unit 124 of the printing device 120 may then access the already stored print resources, whereby the loading of the control unit 124 may be reduced.

To execute a print job, the printing device 120 (in particular the control unit 124) induces a print group 125 of the printing device 120 to print a print image 131 on the recording medium 130. The (rasterized) print resources stored in the storage unit 122 are thereby used.

As has already been presented, print resources may have different respective types. In particular, different resource files may have different types. For example, via the type of resource file or print resource it may be recognized whether the resource file or the print resource describes a font or an image. The type thus indicates how and/or for what purpose the print resource is to be used by the printing device 120.

Print resources of the same type may be identified via a storage path in a file system (in particular in the case of externally stored print resources) and/or via the scope of the print resource (for example via a name of a print data file and/or via a position within the print data file) and/or via the name of the print resource. These parameters may be designated as metadata of a print resource and are to be differentiated from the usable data of a print resource. The usable data typically include information and/or instructions as to how a print image 131 is to be created by the printing device 120. In other words: the usable data of a print resource typically have a direct influence on the graphical reproduction of print data. On the other hand, the metadata include information with regard to the print resource (such as a name of the print resource, for example), the information describing a print resource, but which information is not used by the printing device 120 in order to create a print image 131.

If at least one of the aforementioned parameters of the metadata changes, the print resources are thus considered by the control system 110 to be different and are respectively transferred to the printing device 120. The print resources that are identified to be different are respectively rasterized in the printing device 120 and are stored in the storage unit 122 of the printing device 120. In the case of print resources that—although they have been identified as different due to the aforementioned parameters of the metadata—generate an identical print image when rasterized, it is redundant if both print resources are transferred to the printing device 120, are processed in the printing device 120 and/or are stored in the storage unit 122 of the printing device 120. The redundant provisioning of print resources leads to an unnecessary loading of the transfer medium 142 and/or to an increased demand on the storage capacities of the storage unit 122 and on the control unit 124 of the printing device 120.

In order to provide free storage capacity for new print jobs, print resources may be preventatively deleted from the storage unit 122 of the printing device 120 (for example given transfer of a print job from the control system 110 to the printing device 120). All print resources required for the print job may then subsequently be transmitted (possibly again) to the printing device 120. For example, the preventative deletion of print resources may take place if a parameterizable number of print resources in the storage unit 122 is exceeded.

Alternatively or additionally, the printing device 120 may be set up to inform the control system 110 (for example using a message transmitted via the transfer medium 142) that no more storage space for print resources is free in the storage unit 122. The control system 110 may thereupon initiate the deletion of a specific set of print resources in the storage unit 122. Print resources may then thereupon be transferred again to the printing device 120 within the scope of additional print jobs.

However, the aforementioned procedures are disadvantageous since the deletion of print resources and/or the new provisioning of print resources lead to an increased loading of the control unit 124 of the print device 120. This may (in particular given high-capacity printers) lead to an unwanted start/stop operation and/or decreased print speed and/or to an unwanted spoilage printing.

As was presented above, the identification of print resources on the basis of metadata of the print resources (for example metadata of a resource file) may lead to the situation that print resources that lead to identical print images are nevertheless identified as different. Examples of metadata that may be used for the identification of print resources are:
the name of a print resource or of a resource file;
the storage location of a print resource (for example the path in a file system at which a resource file is stored); and/or
the scope (i.e. the context) in which a print resource is accessed.

The aforementioned metadata typically have no direct influence on the print image 131 to be created by the print device 120 using the print resource. The printing device 120 generates the one or more virtual print images of a print resource (for example the graphical depiction of letters of a font) from the usable data of the print resource (typically without consideration of the metadata).

The redundant transfer, rasterization and storage of print resources leads to an increased loading of the transfer medium 142, the control unit 124 and/or the storage unit 122, and may thus lead to an increased occurrence of start/stop operation and/or decrease of print speed and/or spoilage printing of the printing device 120.

In order to avoid the redundant transfer, rasterization and/or storage of print resources, in this disclosure print resources are identified using the usable data of the print resources (possibly independently of the metadata of the print resources). The usable data of the print resources include the data that are used by the print device 120 to create a print image. If two different print resources (for example two different resource files) have the same usable data (possibly given the presence of the same resource type), it is ensured that these are the same print resources (independently of possible differences of the metadata of the print resources). Via comparison of the usable data of print resources, a redundant transfer, rasterization and/or storage of print resources may thus be reliably avoided. This in turn leads to an avoidance of start/stop operation and/or decrease of print speed and/or spoilage printing of the printing device 120.

FIG. 2 shows an example of print data 200. The print data 200 include a main part 220 in which a document to be printed is described. The main part 220 may thereby include reference to one or more print resources 211 (for example to one or more resource files). In the example shown in FIG. 2, the one or more print resources 211 are a component of a reference part 210 of the print data 200. These are thus what are known as “inline” print resources 211 that are part of the print data 200. Alternatively or additionally, external print resources may also be referenced in the main part 220. The external print resources may be stored in a database and may be referenced via a specific storage path.

The main part 220 of the print data 200 may be subdivided into sub-segments 221, 222. These sub-segments 221, 222 may be hierarchically organized. In the example shown in FIG. 2, sub-segment 222 is part of the sub-segment 221. For example, the sub-segment 222 may be a document which was inserted into a document of the sub-segment 221 and which was created with a different software than the document of the sub-segment 221.

A sub-segment 222 may include print resources 211 that are used only by the print data of the sub-segment 222. The print resources 211 of a sub-segment 222 are typically identified by the “scope” of the print resources 211, i.e. via the context within the print data 200. In particular, in the metadata of the print resource 211 of the sub-segment 222 it may be specified that the print resource 211 relates only to the sub-segment 222.

FIG. 2 furthermore shows an example design of a print resource 211 or of a resource file 211. The print resource 211 may include a header region 231 at the start of the print resource 211 and/or a footer region 233 at the end of the print resource 211. The header region 231 and/or the footer region 233 typically include the metadata as well as the resource type. Furthermore, the print resource 211 includes a usable region 232 that typically includes the usable data of the print resource 211.

The control system 110 may be set up to analyze the print resources 211 (a resource file, for example) of the print data 200 within the scope of the creation of a print job. In particular, the print resources 211 may be identified. The identified print resource 211 may then be provided with an identifier (for example with an identification number). The identifier may be used (possibly in connection with the type of print resource 211) to uniquely identify the print resource 211.

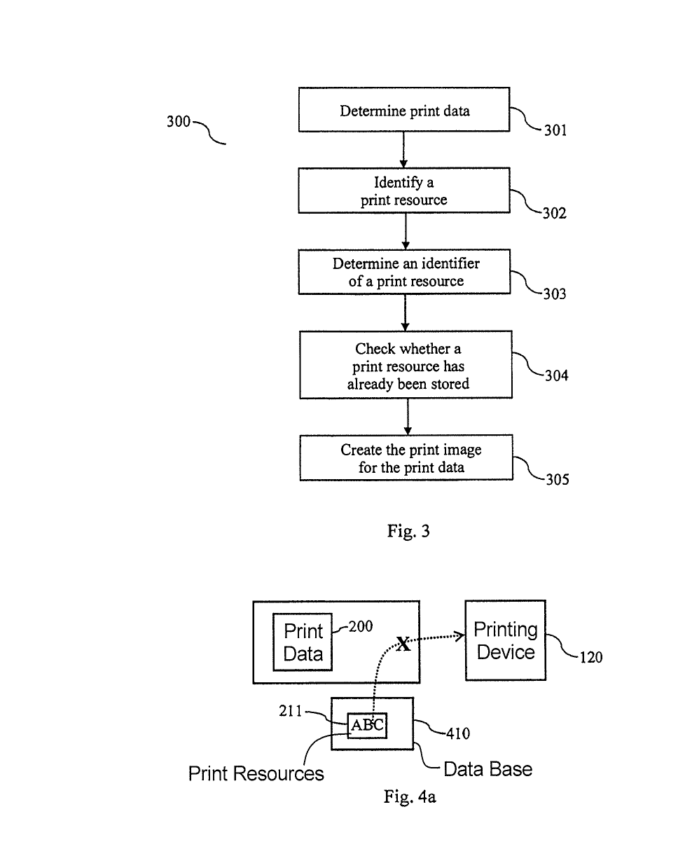

FIG. 3 shows a workflow diagram of a method 300 to determine print resources 211 for the creation of a print image 131 by a printing device 120. For example, the method 300 may be executed by the control unit 114 of the control system 110 (for example as part of a software program running in the control system 110). Alternatively or additionally, the method 300 may be executed by the control unit 124 of the printing device 120.

The method 300 includes the determination 301 of print data 200 from which the printing device 120 should create a print image 131. As described in this document, the print data 200 may be converted into a print job for the printing device 120. For example, the print data 200 may be received in the control system 110 via the transfer medium 141.

Furthermore, the method 300 includes the identification 302 of a first print resource 211 on the basis of the print data 200. As shown in FIG. 2, the print data 200 may refer (for example in the main part 220) to one or more print resources 211 (for example to the first print resource 211). For example, it may be indicated that a specific text should be printed using the first print resource 211. Among other things, the first print resource 211 may thereby describe a typeface or a font. The first print resource 211 may be identified by a reference in the print data 200. This may thereby be a reference to a print resource 211 included in the print data 200 or a reference to an external print resource 211 (which, for example, is stored in an external database). The first print resource 211 that is to be used (in particular a resource file that is to be used) may thus be determined using a reference from the print data 200.

The first print resource 211 includes usable data that enable the print device 120 to determine a graphical depiction of the print image 131. As was already presented above, the usable data may include information with regard to the graphical depiction of individual image points of the print image 131. For example, the usable data may include a description of the graphical depiction of characters of a text format. For this purpose, for example, the usable data may have OpenType font data. In particular, the usable data of print resources 211 may be such that it is ensured that print resources 211 that include the same usable data have the effect that the print device 120 generates identical print images 131 given use of the print resources 211.

In addition to the usable data, the first print resource 211 may also include metadata. The metadata may be used to identify a storage location of the first print resource 211. In particular, the metadata may be used for the reference to the first print resource 211 in the print data 200 (in order to identify the print resource 211 within the print data 200). The metadata typically have no influence on the print image 131 created by the printing device 120.

In particular, the first print resource 211 may include a resource file, wherein the resource file includes the usable data of the first print resource 211 (for example in a usable region 232 of the resource file). Furthermore, the resource file may include metadata (for example in a header region 231 and/or in a footer region 233 of the resource file) that enable the resource file and/or a storage location of the resource file to be identified. For example, the metadata may include a name of the resource file and/or a link to a storage location of the resource file. Alternatively or additionally, the metadata may include information with regard to a context (i.e. a scope) within the print data 200 to which the resource file may be applied.

The method 300 additionally includes the determination 303 of a first identifier of the first print resource 211. The first identifier thereby depends (possibly exclusively) on the usable data of the first print resource 211. In other words, the first identifier may be such that a modification of the usable data of the first print resource 211 automatically leads to a modification of the first identifier (at least with a probability that is greater than or equal to a predefined probability threshold). In particular, the first identifier may be such that the first identifier objectively identifies the usable data of the first print resource 211 (at least with a probability that is greater than or equal to the predefined probability threshold).

On the other hand, the first identifier may be independent of the metadata of the first print resource. It may thereby be ensured that print resources that produce an identical print image but have been stored at different locations and/or are used in different contexts are not identified by different identifiers.

The first identifier may be calculated on the basis of the usable data. For example, a hash value (also designated as a fingerprint) may be determined on the basis of the usable data (for example for all usable data or for a portion of the usable data). For this, a hash function may be used; in particular a cryptologic or cryptographic hash function may be used, for example an MD5 (Message Digest Algorithm 5) or an SHA (Secure Hash Algorithm) hash function. The first identifier may correspond to the hash value determined on the basis of the usable data. The use of a hash function is advantageous since an identifier may be provided for a print resource 211 using a hash function, which identifier takes up relatively little storage space (for example 128 bits or 160 bits) and nevertheless identifies the print resource uniquely with a relatively high probability. In order to further reduce the required storage space for the identifier, the hash value may be truncated (rounded) if necessary.

The first identifier may be explicitly calculated for the first data resource 211. Alternatively or additionally, the first identifier may have already been determined beforehand and may be provided in connection with the first print resource 211. For example, the first identifier may be provided with the print data 200 in the case of “inline” print resource 211.

The method 300 additionally includes a check 304 on the basis of the first identifier as to whether the first print resource 211 is already stored in the storage unit 122 of the printing device 120. As was presented above, print resources 211 used for preceding print data may be stored in the storage unit 122 of the printing device 120. Given reuse of the stored print resources 211, the new rasterization of the print resources 211 may thus be avoided. Furthermore, a new transfer of the print resources 211 may be avoided.

The control system 110 may include information about which print resources 211 are already stored in the storage unit 122 of the printing device 120. In this case, the control system 110 may check whether the first print resource 211 is already stored in the storage unit 122 of the printing device 120 without the first print resource 211 needing to be transferred to the printing device 120. Alternatively or additionally, the first identifier may be transferred to the printing device 120, and on the basis of the first identifier the printing device 120 may check whether the first print resource 211 is already stored in the storage unit 122 of the printing device 120. In this case as well, it is possible that no transfer of the first print resource 211 is necessary. The checking of the availability of the first print resource 211 on the basis of the first identifier thus enables the reduction of the data volume to be transferred to the printing device 120.

Moreover, via the use of an identifier that depends on the usable data of the print resource it may be ensured that print resources that lead to identical print images may be identified reliably. The redundant transfer of print resources 211, the redundant processing (rasterization) of print resources 211 and the redundant storage of print resources 211 in the storage unit 122 of the printing device 120 may thus be avoided.

In particular, one or more already used print resources 211 may be stored in the storage unit 122 of the print device 120 (for example in already rasterized form). The one or more already used print resources 211 may have been used to create print images 131 for past print data 200 (i.e. for print data 200 that are different from the current print data 200 to be printed).

On the basis of the first identifier, a check 304 may be made as to whether the first print resource 211 (that is required to print the current print data 200) coincides with one of the one or more already used print resources 211. If this is the case, a print resource 211 already used for a past print job may be reliably reused.

The method 300 may additionally include the inducement 305 that the print image 131 is created by means of the first print resource 211 stored in the storage unit 122 if it is determined that the first print resource 211 is already stored in the storage unit 122 of the print device 120. A start/stop operation and/or decreased print speed and/or a spoilage printing of the printing device 120 may be avoided via the reliable reuse of print resources 211.

The first print resource 211 may include a resource type. The resource type may indicate which type of usable data is included in the first print resource 211. In other words, the resource type may indicate to the printing device 120 how the usable data of the first print resource 211 are to be interpreted. An example resource type is, for example, a font type that indicates that the usable data of the first print resource 211 describe characters of a font. An additional example of a resource type is, for example, an image type that indicates that the usable data of the first print resource 211 describe an image (a logo, for example).

On the basis of the resource type, a check may also be made as to whether the first print resource 211 is already stored in the storage unit 122 of the print device 120. In particular, it may be checked whether a print resource 211 is stored in the storage unit 122, which print resource 211 has an identifier that corresponds to the first identifier and that has a resource type that corresponds to the resource type of the first print resource 211.

For example, a second print resource 211 may be stored in the storage unit 122 of the printing device 120. A second identifier may be stored for the second print resource 211. The second identifier may have been determined as described in this document. In particular, the second identifier may be dependent (possibly exclusively) on usable data of the second print resource 211. The check step 304 may then include the comparison of the first identifier and the second identifier. Furthermore, the method 300 may include that it is induced in step 305 that the print image 131 is created by means of the second (stored and possibly rasterized) print resource 211 (and not by means of the first print resource 211) if it is determined that the first identifier coincides with the second identifier.

A print resource 211 may thus be identified—in particular by the control system 110—by means of an identifier (for example by means of a fingerprint, for instance an MD5 hash value). The identifier may possibly precede the print resource 211 (for example as part of the header region 231), or the identifier may be calculated via the control system 110.

Recurring print resources 211 (in particular fonts) are thus reliably identified and do not need to be repeatedly transferred to the printing device 120, and may be used in the printing device 120. The method 300 described in this document thus enables a continuous printing of print data 200 (without start/stop or decreased print speed or spoilage printing).

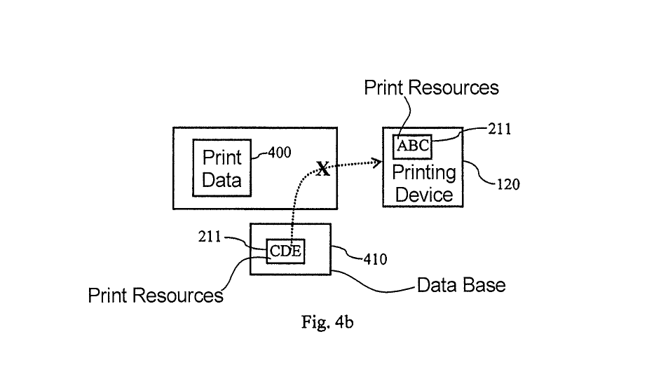

FIGS. 4a and 4b illustrate the reuse of print resources 211 in successive print jobs. The control system 110 may receive a plurality of print jobs, meaning a plurality of print data 200, 400. Each print job may include different print files. The print files may reference a resource database 410 (a file index, for example) in which print resources 211 for the print files are stored.

In FIG. 4a it is shown how a first print job 200 is printed. The first print job 200 references a print resource “ABC” 211 of type X. This print resource 211 is located in the resource library #a in the resource database 410, which resource library #a belongs to the print job 200. This print resource 211 is transferred to the printing device 120, rasterized in the printing device 120 and stored.

A second print job 400 is subsequently printed (see FIG. 4b), wherein a print resource “CDE” 211 of type X is referenced in the print job 400. The print resource “CDE” 211 is located in a resource library #b in the resource database 410. The print resource “CDE” 211 thus has a different name and/or is stored at a different storage location than the print resource “ABC” 211.

However, the determination of identifiers (in particular of fingerprints) for the print resources “ABC” and “CDE” enables it to be reliably determined whether the print resources “ABC” and “CDE” are identical. The control system 110 checks whether the identifiers of the print resources “ABC” and “CDE” are the same. If this is the case, the print resource “CDE” does not need to be transferred to the printing device 120. Instead of this, the print resource “ABC” that was already stored in the printing device 120 may be reused. The control system 110 may then adapt the print job 400 such that the print resource “ABC” is referenced in the created print job instead of the print resource “CDE”. The print resource “CDE” then no longer needs to be transferred to the print device 120.

As was already presented above, the method 300 described in this document may be executed by the control unit 114 of the control system 110 and/or by the control unit 124 of the printing device 120. A control unit 114, 124 to control a printing device 120 is thus described in this document. The control unit 114, 124 is set up to determine print data 200 (for example a print job or a print file) from which the printing device 120 should create a print image 131. The control unit 114, 124 is furthermore set up to identify a first print resource 211 on the basis of the print data 200. The first print resource 211 thereby includes usable data that enable the printing device 120 to determine a graphical depiction of the print image 131. Furthermore, the control unit 114, 124 is set up to determine a first identifier of the first print resource 211. The first identifier is thereby dependent on the usable data of the first print resource 211. Moreover, the control unit 114, 124 is set up to check —on the basis of the first identifier—whether the first print resource 211 is already stored in a storage unit 122 of the printing device 120. The control unit 114, 124 may furthermore be set up to induce the print image 131 to be created by means of the first print resource 211 stored in the storage unit 122 if it is determined that the first print resource 211 is already stored in the storage unit 122.

The method 300 described in this document may be provided within the scope of a software program (for example as a printer driver or as a control software). A software (SW) program is thus described in this document. The SW program may be set up in order to be executed in a processor (for example in a control unit 114, 124) and in order to thereby execute the method 300 described in this document.

Furthermore, a storage medium is described in this document. The storage medium may include a SW program which is set up in order to be executed in a processor, and in order to thereby execute the method 300 described in this document.

The present invention is not limited to the shown exemplary embodiments. In particular, it is to be noted that the Specification and Figures illustrate only the principle of the proposed methods, devices and systems.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

I claim as our invention:

1. A method to determine print resources for creation of a print image via a printing device, comprising the steps of:
determining via a control system print data from which the printing device should create a print image;
identifying via the control system a first print resource based on the print data, a resource file of the first print resource including usable data that enable the printing device to determine a graphical depiction of the print image, and the resource file including metadata that enable the resource file to be identified;
determining via the control system a first identifier of the first print resource, the first identifier depending on the usable data of the first print resource, and the first identifier being independent of the metadata;
based on the first identifier, checking whether the first print resource is already stored in a storage unit of the printing device; and
inducing via the control system the print image to be created by means of the first print resource stored in the storage unit, the first print resource not being re-transferred from the control system to the printing device if it is determined that the first print resource is already stored in the storage unit.

2. The method according to claim 1 wherein:
the control system comprises a server with a control software for the printing device; and
the printing device comprises a control unit that is set up to rasterize the resource file.

3. The method according to claim 1 wherein the metadata include at least one of:
a name of the resource file;
a link to a storage location of the resource file; and
information with regard to a context within the print data to which the resource file is applicable.

4. The method according to claim 1 wherein the usable data include at least one of:
information with regard to a graphical depiction of individual image points of the print image;
a description of a graphical depiction of characters of a font format; and
open type font data.

5. The method according to claim 1 wherein the determination of the first identifier includes determination of a hash value based on the usable data using a hash function.

6. The method according to claim 5 wherein the hash function includes a cryptologic hash function.

7. The method according to claim 1 wherein:
the first print resource includes a resource type; and
based on resource type a check is made as to whether the first print resource is already stored in the storage unit of the print device.

8. The method according to claim 1 wherein:
a second print resource is stored in the storage unit;
a second identifier for the second print resource is stored;
the second identifier is dependent on usable data of the second print resource; and
the checking includes comparison of the first identifier and the second identifier.

9. The method according to claim 8 wherein it is induced that the print image is created by means of the second print resource if it is determined that the first identifier coincides with the second identifier.

10. The method according to claim 1 wherein the first print resource is included in the print data.

11. The method according to claim 1 wherein:
at least one print resource that has already been used is stored in the storage unit, the print resource having been used to create print images for past print data; and
based on the first identifier, a check is made as to whether the first print resource coincides with at least one of the print resources that has already been used.

12. A control system for a printing device, said control system performing the steps of:
determining print data from which the printing device should create a print image;
identifying a first print resource based on the print data, the first print resource including a resource file, the resource file including usable data that enable the print device to determine a graphical depiction of the print image, and the resource file including metadata that enable the resource file to be identified;
determining a first identifier of the first print resource, the first identifier being dependent on the usable data of the first print resource, and the first identifier being independent of the metadata;
based on the first identifier, checking whether the first print resource is already stored in a storage unit of the printing device; and
inducing the print image to be created by means of the first print resource stored in the storage unit, the first print resource not being re-transferred from the control system to the printing device if it is determined that the first print resource is already stored in the storage unit.

13. A method to determine print resources for creation of a print image via a printing device, comprising the steps of:
determining via a control system print data from which the printing device should create a print image;
identifying via the control system a first print resource based on the print data, a resource file of the first print resource including usable data that enable the printing device to determine a graphical depiction of the print image, and the resource file including metadata that enable the resource file to be identified;
determining via the control system a first identifier of the first print resource, the first identifier depending on the usable data of the first print resource, and the first identifier being independent of the metadata;
based on the first identifier, checking whether the first print resource is already stored in a storage unit of the printing device; and
inducing via the control system the print image to be created by means of the first print resource stored in the storage unit the first print resource not being re-transferred from the control system to the printing device if it is determined, based on the first identifier, that the first print resource is already stored in the storage unit.
